(19) United States
(12) Patent Application Publication
(10) Pub. No.: US 2021/0003885 A1
(43) Pub. Date: Jan. 7, 2021

(54) LIGHTING DEVICE AND DISPLAY DEVICE

(71) Applicant: Sharp Kabushiki Kaisha, Osaka (JP)

(72) Inventor: Mitsuru HOSOKI, Sakai City (JP)

(21) Appl. No.: 16/458,345

(22) Filed: Jul. 1, 2019

(51) Int. Cl. G02F 1/1335; G02F 1/1333

(52) U.S. Cl. CPC G02F 1/133603; G02F 1/133615; G02F 1/133308

(57) ABSTRACT

A lighting device includes light sources, at least one light source board on which the light sources are mounted, a chassis including a bottom section on which the at least one light source board is arranged and including a recessed portion on the bottom section, and a connector for electric connection arranged on a portion of the at least one light source board so as to overlap the recessed portion. The at least one light source board includes a portion surrounding the connector and includes at least one projected section on at least a part of the portion, and the projected section projects further than other part of the portion in a plate surface direction of the at least one light source board.

### TECHNICAL FIELD

The present invention relates to a lighting device and a display device.

### BACKGROUND

There has been known in an image display device that a chassis made of metal is disposed on a back surface side of a display panel and a recessed portion projecting toward an opposite side from the display panel is provided on a portion of a flat surface of the chassis. One example of such an image display device is described in Japanese Unexamined Patent Application Publication No. 2012-53082. In the image display device, the recessed portion is formed with pressing to increase rigidity of the chassis.

In an assembling process, a light source board on which light sources (such as LEDs) are mounted is disposed on the chassis including such a recessed portion, and a connector for power supply is inserted in the light source board. In such an insertion step, if the light source board is warped into an inner space of the recessed portion, the insertion of the connector is not completed and a connection error may be caused. If the connector is inserted with stronger force to avoid such an error, the light source board may be deformed to be warped into the inner space of the recessed portion.

### SUMMARY

The technology described herein was made in view of the above circumstances. An object is to make electric connection between a light source board and a connector more surely.

(1) A lighting device according to one embodiment of the present invention includes light sources, at least one light source board on which the light sources are mounted, a chassis including a bottom section on which the at least one light source board is arranged and including a recessed portion on the bottom section, and a connector for electric connection arranged on a portion of the at least one light source board so as to overlap the recessed portion. The at least one light source board includes a portion surrounding the connector and includes at least one projected section on at least a part of the portion, and the projected section projects further than other part of the portion in a plate surface direction of the at least one light source board.

(2) In addition to the configuration (1), in another embodiment of the present invention, the at least one light source board has an elongated shape, and the connector is disposed on an end portion of the at least one light source board and inserted in a mount surface of the at least one light source board.

(3) In addition to the configuration (2), in another embodiment of the present invention, the at least one projected section projects in a direction crossing an elongated direction of the at least one light source board.

(4) In addition to the configuration (2) or (3), in another embodiment of the present invention, the at least one light source board includes a first end portion where the connector is disposed and a second end portion that is on an opposite side from the first end portion. The second end portion includes a recessed section, and the recessed section has a shape that follows a shape of the at least one projected section.

(5) In addition to one of the configurations (2) to (4), in another embodiment of the present invention, the at least one projected section includes projected sections and the at least one light source board has two long side surfaces that have the projected sections, respectively.

(6) In addition to any one of the configurations (2) to (5), in another embodiment of the present invention, the at least one light source board includes a body section that has an elongated quadrangular shape and on which the light sources are mounted, and the at least one projected section is integrally formed with the body section.

(7) In addition to the configuration (6), in another embodiment of the present invention, the at least one light source board includes light source boards, and the light source boards are arranged such that the body sections are parallel to each other.

(8) In addition to the configuration (7), in another embodiment of the present invention, each of the light source boards includes a first end portion where the connector is disposed and a second end portion that is on an opposite side from the first end portion, and the light source boards are arranged such that the first end portion of each of the light source boards is next to each other.

(9) In addition to the configuration (7) or (8), in another embodiment of the present invention, the light source boards are arranged entirely over the bottom section.

(10) In addition to any one of the configurations (1) to (9), in another embodiment of the present invention, the chassis includes a side section extending from an outer edge of the bottom section at a predetermined angle with respect to the bottom section, and a line that is connected to the connector is arranged in a space between the at least one light source board and the side section.

(11) In addition to any one of the configurations (1) to (10), in another embodiment of the present invention, the light sources are LEDs, and the connector is a connector for power supply.

(12) In addition to any one of the configurations (1) to (11), in another embodiment of the present invention, the at least one projected section has a projected length of at least 2 mm.

(13) A display device according to another embodiment of the present invention includes the lighting device according to any one of the configurations (1) to (12) and a display panel to which light from the lighting device is supplied.

(14) In addition to the configuration (13), in another embodiment of the present invention, the display panel is a liquid crystal panel.

According to the technology described herein, connection between the connector and the light source board can be improved.

### BRIEF DESCRIPTION OF THE DRAWINGS

FIG. 1 is a cross-sectional view of a liquid crystal display device according to a first embodiment.

FIG. 2 is a plan view of LEDs, LED boards, and a chassis.

FIG. 3 is a perspective view illustrating a connector that is to be inserted in the LED board.

FIG. 4 is a perspective view illustrating the connector that is to be inserted in the LED board.

FIG. 5 is a plan view of LEDs, LED boards, and a chassis according to a second embodiment.

FIG. 6 is a plan view of LEDs, LED boards, and a chassis according to a third embodiment.

FIG. 7 is a plan view illustrating a substrate plate having cut lines for the LED boards according to the third embodiment.

### DETAILED DESCRIPTION

### First Embodiment

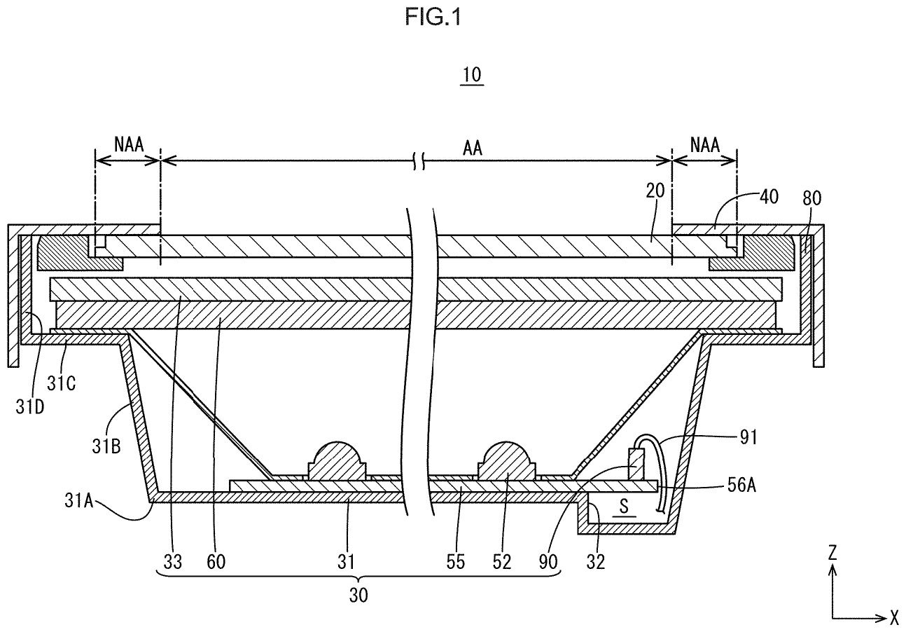

A liquid crystal display device 10 (one example of a display device) according to a first embodiment will be described with reference to FIGS. 1 to 3. The liquid crystal display device 10 includes a liquid crystal panel 20 (one example of a display panel) and a backlight unit 30 (one example of a lighting device). X-axis, Y-axis and Z-axis may be present in FIGS. 1 to 6 and each of the axial directions represents a direction represented in each drawing. A liquid crystal panel 20 side and a backlight unit 30 side with respect to the Z-axis direction are defined as a front side and a back side, respectively.

The liquid crystal panel 20 is configured to display an image. The liquid crystal panel 20 has a laterally elongated quadrangular overall shape. The liquid crystal panel 20 has a screen size of about 45 inches and is generally classified into a middle size. The liquid crystal panel 20 includes two transparent glass substrates and two polarizing plates. The glass substrates are bonded to each other while having a predetermined gap therebetween and a liquid crystal layer is sealed between the two glass substrates. The polarizing plates are bonded to outer surfaces of the glass substrates, respectively. The backlight unit 30 is configured to supply light to the liquid crystal panel 20. As illustrated in FIG. 1, the liquid crystal display device 10 further includes a bezel 40 and a frame 80 that have a frame shape and hold collectively the liquid crystal panel 20 and the backlight unit 30.

As illustrated in FIG. 1, the backlight unit 30 includes a backlight chassis 31 (one example of a chassis), one hundred and twenty LEDs 52 (one example of a light source), fifteen LED boards 55 (one example of a light source board), a diffuser plate 60, an optical sheet 33, a reflection sheet 70, and fifteen connectors 90 for electric connection. The backlight chassis 31 has a substantially box shape that opens toward the front side, and the LEDs 52, the LED boards 55, and the reflection sheet 70 are arranged therein. The diffuser plate 60 is disposed to cover an opening of the backlight chassis 31. The optical sheet 33 applies predetermined optical effects to the light that has exited the diffuser plate 60. The LEDs 52 are mounted on each of the LED boards 55 so as to face a back surface of the diffuser plate 60. The reflection sheet 70 reflects the light that is inside the backlight chassis 31 toward the diffuser plate 60. The backlight unit 30 is a so-called direct type backlight unit and includes the LEDs 52 that are arranged in a planar form on the rear side of the liquid crystal panel 20. Next, components of the backlight unit 30 will be described in detail.

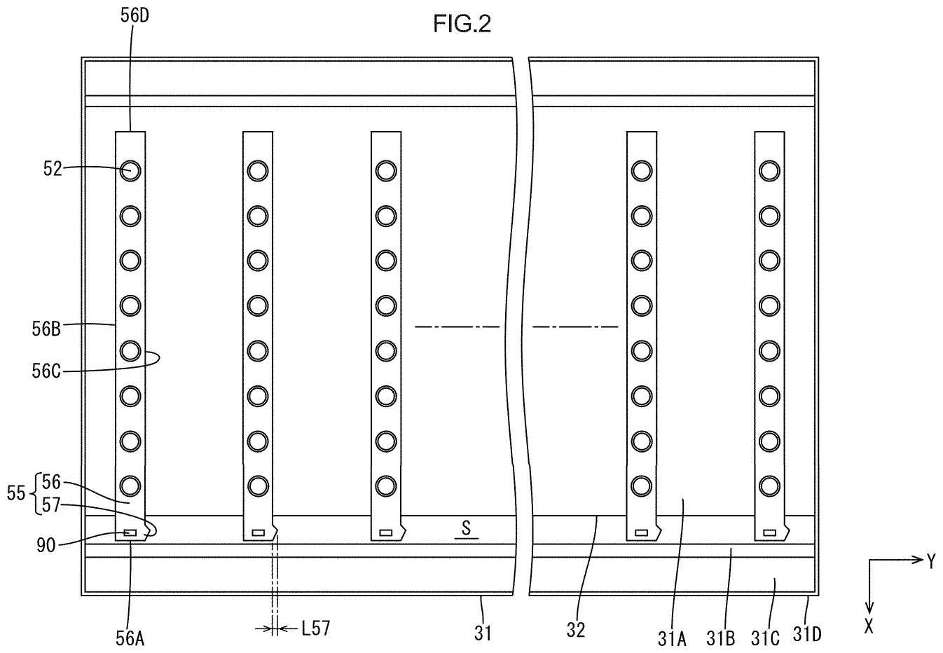

The backlight chassis 31 is made of metal or resin. As illustrated in FIGS. 1 and 2, the backlight chassis 31 includes a bottom section 31A, side sections 31B, a receiver section 31C, and side plates 31D. The bottom section 31A has a laterally elongated quadrangular shape similar to that of the liquid crystal panel 20 and includes a recessed portion that projects toward the back side of the backlight chassis 31. Each of the side sections 31B extends from an outer edge of each side of the bottom section 31A at a predetermined angle with respect to the bottom section 31A toward the front side. The receiver section 31C extends outward from an extended end of each side section 31B and the side plates 31D extend from an outer edge of the receiver section 31C toward the back side.

As illustrated in FIG. 2, the recessed portion 32 is near one of long sides of the bottom section 31A that extend in the Y-axis direction. The recessed portion 32 extends along the long side. The recessed portion 32 is formed by pressing the bottom section 31A such that a portion of the bottom section 31A is recessed toward the back side with pressing. Accordingly, rigidity of the bottom section 31A is increased. The recessed portion 32 has an inner space S therein and lines 91 for supplying power to the LED boards 55 are arranged in the inner space S. A back side outer surface of the recessed portion 32 may be used as a base on which a control board for supplying driving signals to the liquid crystal panel 20 is mounted.

As illustrated in FIG. 1, the diffuser plate 60 is thicker than the optical sheet 33 and outer edge portions of the diffuser plate 60 are on the receiver section 31C of the backlight chassis 31 while having the reflection sheet 70 therebetween. Light that is emitted by the LEDs 52 and directed in the Z-axis direction enters the diffuser plate 60 through a back side plate surface of the diffuser plate 60 and exits the diffuser plate 60 through a front side plate surface of the diffuser plate 60 toward the optical sheet 33. The light is diffused by the diffuser plate 60 and the diffused light rays reach the optical sheet 33.

As illustrated in FIG. 1, the optical sheet 33 is between the liquid crystal panel 20 and the diffuser plate 60 and configured to apply predetermined optical effects to the light rays that have exited the diffuser plate 60. The light exits the optical sheet 33 toward the liquid crystal panel 20.

The reflection sheet 70 has a white surface that is good in light reflectivity. As illustrated in FIG. 1, the reflection sheet 70 has a size that covers a substantially entire inner surface area of the backlight chassis 31. The reflection sheet 70 has a square bowl overall shape and reflects light that leaks from the LEDs 52 or the back surface of the diffuser plate 60 toward the diffuser plate 60.

As illustrated in FIG. 2, eight LEDs 52 are arrayed at equal intervals on a mount surface of each of the LED boards 55. The LEDs 52 are electrically connected to each other with wiring that is disposed within a surface area of the LED board 55. Power (forward current) is supplied to the LEDs 52 through the wiring and the LEDs emit light. The LED 52 is a so-called top surface light emission type (a top view type) and a bottom surface of the LED 52 is on the mount surface.

As illustrated in FIG. 2, each of the LED boards has a thin elongated plate shape that extends along a short side (namely, the X-axis direction) of the bottom section 31A. The LED boards 55 are arranged over a whole area of the bottom section 31A of the backlight chassis 31 ranging from a first short side to a second short side. If a Y-axis dimension of each LED board 55 is 1.5 cm, for example, an interval between the LED boards 55 in the Y-axis direction is from about 6 cm to 7 cm. The LED board 55 includes a body section 56 that has an elongated quadrangular shape of LEDs 52 and a projected section 57. The body section 56 includes a first end portion 56A that overlaps the recessed portion 32 and a second end portion 56D that is opposite from the first end portion 56A. The connector 90 is arranged on the first end portion 56A.

As illustrated in FIG. 1, the connector 90 is inserted in the LED board 55 through the mount surface thereof. According to such a configuration, a space between the LED board 55 and the side section 31B of the backlight chassis 31 can be decreased and the bezel 40 is reduced in its size. The connector 90 is connected to the line 91 through which power is supplied to the LED board 55 and power is supplied to the LED board 55 and eventually to the LEDs 52 through the line 91 and the connector 90. The LED boards 55 are electrically connected to each other by the lines 91. A part of each line 91 is arranged in a space between the LED board 55 and the side section 31B.

As illustrated in FIG. 2, the LED boards 55 are arranged such that the first end portions 56A are next to each other. The work efficiency of inserting the connectors 90 can be improved and the line 91 between the LED boards 55 can be shortened.

Each projected section 57 projects from a side surface of a portion of the body section 56 in a plate surface direction of the LED board 55. The portion of the body section 56 surrounds the connector 90. The projected section 57 is integrally formed with the body section 56 and has a triangular shape that projects in a direction (the Y-axis direction) crossing the longitudinal direction of the body section 56. If the projected section 57 projects in the longitudinal direction of the body section 56 (the X-axis direction), the longitudinal dimension of the LED board 55 becomes greater by the dimension of the projected section 57. The projected section 57 projects in the direction crossing the longitudinal direction and therefore, an extra space is not necessary to be provided in an outer edge area of the backlight unit 30. A projected length L57 of the projected section 57 is preferably at least about 2 mm.

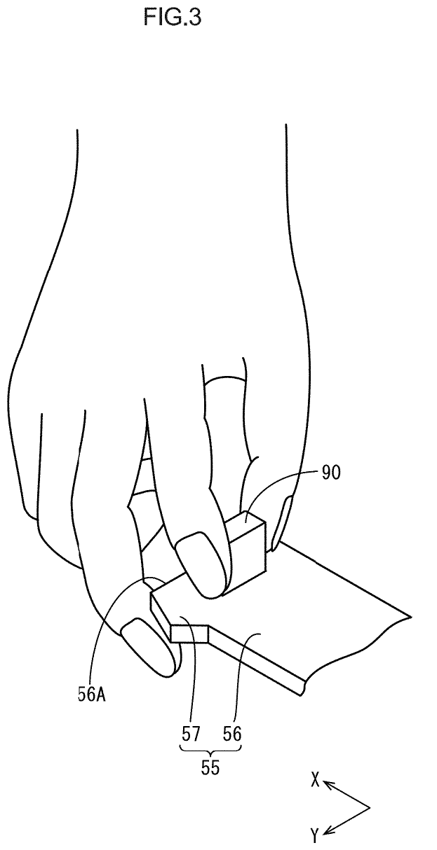

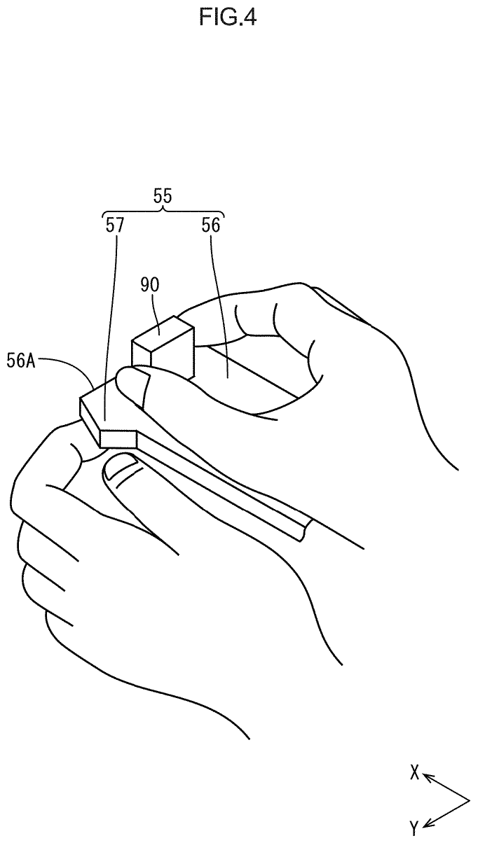

According to the above configuration, in the assembling process of the backlight unit 30, as illustrated in FIG. 3, an operator holds the connector 90 with the operator's thumb and index finger and inserts the connector 90 while supporting the back surface of the projected section 57 with the operator's middle finger or ring finger to pull up the projected section 57 from the back side. As illustrated in FIG. 4, an operator holds the connector 90 with fingers of one hand and inserts the connector 90 while supporting the back surface of the projected section 57 with fingers of the operator's other hand to pull up the projected section 57 from the backs side. Accordingly, the connector 90 can be inserted in the mount surface of the LED board 55 completely such that the LED board 55 is not warped into the inner space S of the recessed portion 32 in the step of inserting the connector 90. As a result, electric connection of the connector 90 can be surely made. The projected section 57 projects in the direction crossing the elongated direction. When the connector 90 is held with a thumb and an index finger, a finger such as a middle finger is easily put on the projected section 57. The projected section 57 is supported by an operator in the inserting operation. Therefore, the LED board 55 is less likely to be deformed to be warped into the inner space S of the recessed portion 32.

### Second Embodiment

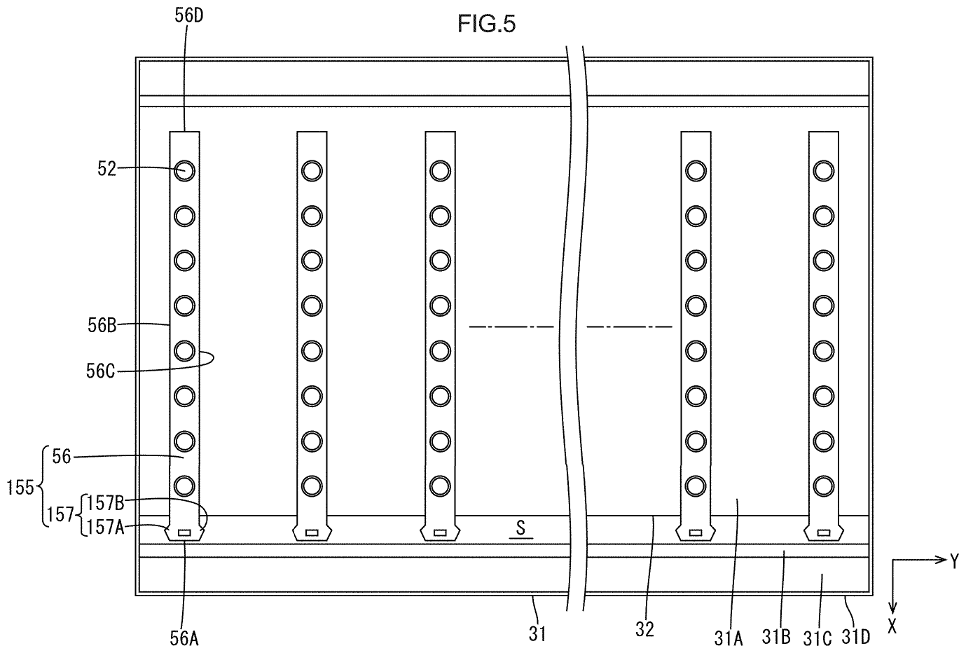

A LED board 155 according to a second embodiment will be described with reference to FIG. 5. The LED board 155 includes the body section 56 and a projected section 157. The projected section 157 is included on a first long side surface 56B and a second long side surface 56C of the body section 56. Other configuration is similar to that of the first embodiment, and configurations, operations, and effects similar to those of the first embodiment will not be described.

The projected section 157 includes a first projected section 157A that is integrally formed with the first long side surface 56B and a second projected section 157B that is integrally formed with the second long side surface 56C. An operator can access the projected section 157 from both sides of a first long side surface 56B side and a second long side surface 56C side. Specifically, an operator can put a finger on one of the first projected section 157A or the second projected section 157B to insert the connector 90 through a mount surface of the LED board 155 completely. An operator can easily put his/her finger on the projected section 157 regardless of a right-handed person or a left-handed person and operability can be freely improved. Furthermore, the projected section 157 is visually outstanding. Therefore, when an operator arranges the LED boards 155 on the bottom section 31A of the backlight chassis 31, the operator is less likely to arrange the LED boards 155 with wrong directions and is likely to arrange the LED boards 155 with a correct direction such that the projected section 157 overlaps the recessed portion 32.

### Third Embodiment

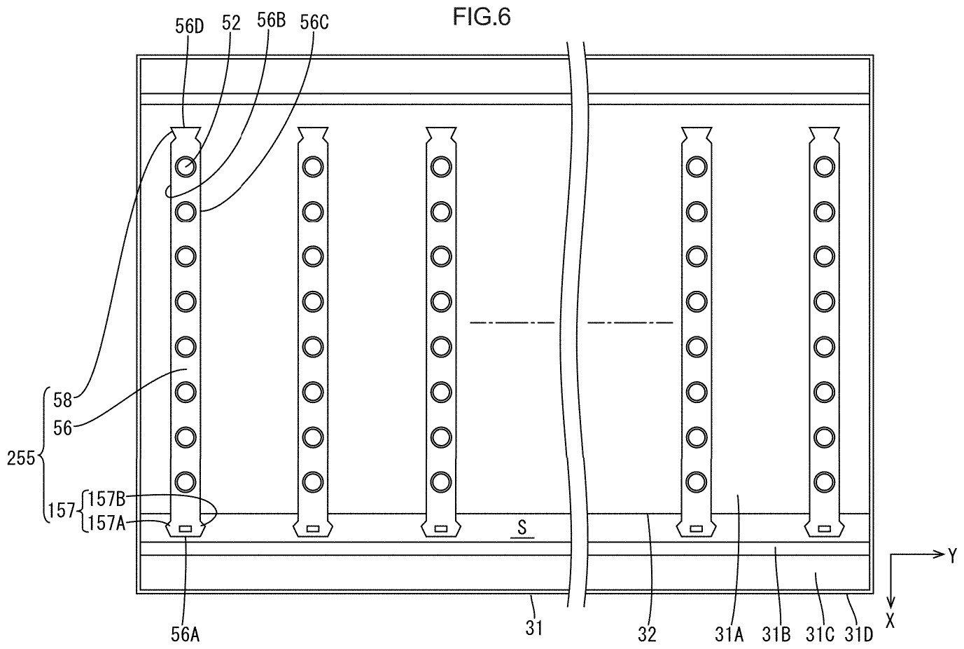

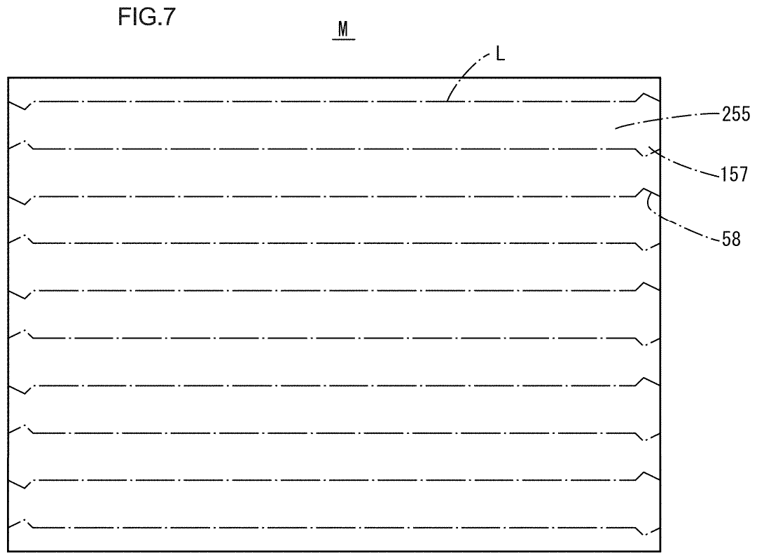

A LED board 255 according to a third embodiment will be described with reference to FIGS. 6 and 7. The LED board 255 includes a recessed section 58 at the second end portion 56D where no connector 90 is disposed. Other configuration is similar to those of the first embodiment and the second embodiment, and configurations, operations, and effects similar to those of the first embodiment and the second embodiment will not be described.

As illustrated in FIG. 7, the LED board 255 is cut out from a quadrangular substrate plate M into a predetermined shape. Therefore, if the substrate plate M is cut into pieces each having a shape same as that of the projected section 57 of the second embodiment, the recessed section 58 that is formed along the shape of the projected section 157 is formed on the substrate plate M. Therefore, if cutting lines L are drawn on the substrate plate M such that the projected sections 157 are not provided next to each other and are formed on every other LED board and the LED boards 255 are cut out, the substrate plate M can be effectively used and wasted cut pieces are not created. The cut out LED boards 255 are arranged such that the projected sections 157 are arranged next to each other as illustrated in FIG. 6, the operations and effects similar to those of the second embodiment can be obtained.

### Other Embodiments

The present technology described herein is not limited to the embodiments described in the above descriptions and drawings. The following embodiments may be included in the technical scope.

(1) The shape of the projected section 57 may be other shapes such as a square or a semicircular shape as long as it projects.

(2) The number, the size, and the intervals of the LEDs 52 and the LED boards 55, 155, 255 are examples and may be other numbers and other dimensions.

(3) The bottom section 31A of the backlight chassis 31 may include multiple recessed portions that are similar to the recessed portion 32.

(4) The number, the size, and the shape of the connectors 90 are examples and may be other numbers, other dimensions, and other shapes. The connectors may be connectors for electric connection that are used for other than power supply.

(5) The liquid crystal display device 10 may have a vertically elongated quadrangular shape or a non-quadrangular shape.

(6) The backlight unit 30 may be a side edge type and LED boards mounted in such a backlight unit may be included in the technical scope.

(7) The liquid crystal display device 10 may have a size other than a middle size and LED boards mounted in such a liquid crystal display device may be included in the technical scope.

1. A lighting device comprising:
light sources;
at least one light source board on which the light sources are mounted;
a chassis including a bottom section on which the at least one light source board is arranged and including a recessed portion that projects from the bottom section toward a back side of the chassis; and
a connector that electrically connects and is arranged on a portion of the at least one light source board to overlap the recessed portion, wherein the at least one light source board includes a portion surrounding the connector and includes at least one projected section on at least a first portion of the portion surrounding the connector, and
the at least one projected section projects further than a second portion of the portion surrounding the connector in a plate surface direction of the at least one light source board.

2. The lighting device according to claim 1, wherein
the at least one light source board has an elongated shape,
the connector is on an end portion of the at least one light source board and inserted in a mount surface of the at least one light source board, and
at least one light source among the light sources is mounted on the mount surface of the at least one light source board.

3. The lighting device according to claim 2, wherein the at least one projected section projects in a direction crossing an elongated direction of the at least one light source board.

4. The lighting device according to claim 2, wherein
the at least one light source board includes a first end portion where the connector is disposed and a second end portion that is on an opposite side from the first end portion,
the second end portion includes a recessed section, and
the recessed section has a shape that follows a shape of the at least one projected section.

5. The lighting device according to claim 2, wherein
the at least one light source board further includes at least another projected section on at least the first portion of the portion surrounding the connector,
the at least one projected section and the at least another projected section project further than the second portion of the portion surrounding the connector in a plate surface direction of the at least one light source board, and
the at least one light source board includes one long side surface that includes the at least one projected section and another long side surface that includes the at least another projected section.

6. The lighting device according to claim 2, wherein
the at least one light source board includes a body section that has an elongated quadrangular shape and on which the light sources are mounted, and
the at least one projected section is integrally formed with the body section.

7. The lighting device according to claim 6, further comprising light source boards including the at least one light source board, wherein the light source boards are arranged such that their body sections are parallel to each other.

8. The lighting device according to claim 7, wherein
each of the light source boards includes a first end portion where the connector is disposed and a second end portion that is on an opposite side from the first end portion, and
the light source boards are arranged such that the first end portion of each of the light source boards is next to each other.

9. The lighting device according to claim 7, wherein the light source boards are arranged entirely over the bottom section.

10. The lighting device according to claim 1, wherein
the chassis includes a side section extending from an outer edge of the bottom section at a predetermined angle with respect to the bottom section, and
a line that is connected to the connector is arranged in a space between the at least one light source board and the side section.

11. The lighting device according to claim 1, wherein
the light sources are LEDs, and
the connector is a connector for power supply.

12. The lighting device according to claim 1, wherein the at least one projected section has a projected length of at least 2 mm.

13. A display device comprising:
the lighting device according to claim 1; and
a display panel to which light from the lighting device is supplied.

14. The display device according to claim 13, wherein the display panel is a liquid crystal panel.

15. The lighting device according to claim 6, wherein
the connector is on the body section,
the at least one projected section projects from a side surface of the portion surrounding the connector in a direction crossing an elongated direction of the body section, and
the body section includes the portion surrounding the connector.

16. The lighting device according to claim 6, wherein
the connector is on the body section,
the at least one projected section projects from a portion of a long side surface of the body section, and
the at least one projected section extends in a direction orthogonal to an elongate direction of the body section from the connector.
